(19) United States
(12) Patent Application Publication
(10) Pub. No.: US 2024/0390223 A1
(43) Pub. Date: Nov. 28, 2024

(54) CARDIOPULMONARY RESUSCITATION APPARATUS CONTROLLED BY HUMAN VITAL SIGNS

(71) Applicant: KING FAISAL UNIVERSITY, Al-Ahsa (SA)

(72) Inventors: Ahmed Sulaiman Ahmed ALSAFRAN, Al-Ahsa (SA); Zainab Ali A AL SADIQ, Al-Ahsa (SA); Arwa Abdullah Ibrahim AL-MUBARAK, Al-Ahsa (SA); Sarah Abdulwahab Ali ALGHAZAL, Al-Ahsa (SA); Hadeel Hesham Yousef BUALI, Ah-Ahsa (SA); Wejdan Yasser Ali ALOLAIWY, Al-Ahsa (SA)

(21) Appl. No.: 18/202,415

(22) Filed: May 26, 2023

(51) Int. Cl. A61H 31/00

(52) U.S. Cl. CPC A61H 31/006; A61H 2201/0176; A61H 2201/1207; A61H 2201/123; A61H 2201/1619; A61H 2201/1621; A61H 2201/1664; A61H 2201/5046; A61H 2201/5058; A61H 2203/0456; A61H 2205/084; A61H 2230/045; A61H 2230/065; A61H 2230/208

(57) ABSTRACT

The automated cardiopulmonary resuscitation apparatus is a portable device for automatically performing chest compression on a patient in need thereof. The automated cardiopulmonary resuscitation apparatus includes a linear actuator having an extendable and retractable piston. A mount is provided for positioning the linear actuator above the chest of the patient, such that the piston is positioned above the patient's heart. At least one sensor is provided for measuring the patient's pulse and blood oxygen level. A controller is in communication with the linear actuator and the at least one sensor. The controller is configured to drive the linear actuator to reciprocally extend and retract the piston such that a free end of the piston compresses the chest of the patient at a regular interval. Operation of the linear actuator ceases when the patient's pulse is determined to be at or above a first predetermined threshold.

### BACKGROUND

### Field

The disclosure of the present patent application relates to cardiopulmonary resuscitation in a patient in need thereof, and particularly to an automated apparatus for applying chest compression to a patient.

### Description of Related Art

Cardiopulmonary resuscitation (CPR) is an emergency procedure consisting of chest compressions which are often combined with artificial ventilation to manually preserve intact brain function until further measures are taken to restore spontaneous blood circulation and breathing in a person who is in cardiac arrest. CPR is recommended for those who are unresponsive with no breathing or abnormal breathing, for example, agonal respirations.

CPR involves chest compressions for adults between 5 cm and 6 cm deep and at a rate of at least 100 to 120 per minute. Maintaining both the proper depth and rate of chest compression is difficult and requires the full attention of the person delivering CPR to the patient, thus preventing the person delivering CPR from performing other interventions. Additionally, the person delivering chest compressions will typically become fatigued relatively rapidly, resulting in decreased quality of the compressions. Further, chest compressions may be difficult to apply in limited-space environments, such as alr ambulances. Thus, an automated cardiopulmonary resuscitation apparatus solving the aforementioned problems is desired.

### SUMMARY

The automated cardiopulmonary resuscitation apparatus is a portable device for automatically performing chest compression on a patient in need thereof. The automated cardiopulmonary resuscitation apparatus includes a linear actuator having an extendable and retractable piston. A mount is provided for positioning the linear actuator above the chest of the patient, such that the piston is positioned above the patient's heart. At least one sensor is provided for measuring the patient's pulse and blood oxygen level. A controller is in communication with the linear actuator and the at least one sensor. The controller is configured to drive the linear actuator to reciprocally extend and retract the piston such that a free end of the piston compresses the chest of the patient at a regular interval. Operation of the linear actuator ceases when the patient's pulse is determined to be at or above a first predetermined threshold. As a non-limiting example, when the patient's measured pulse rate is at or above a predetermined minimum pulse rate, chest compression is stopped. As another non-limiting example, when the patient's measured pulse strength (or amplitude) is at or above a predetermined minimum pulse strength (or amplitude), chest compression is stopped.

Initial operation of the linear actuator may also be based on measurements from the at least one sensor. The controller may be further configured to initiate operation of the linear actuator when at least one of the patient's pulse and the patient's blood oxygen level is at or below a second predetermined threshold. The mount may be secured to the patient using any suitable type of attachment or stabilizer. As an example, a releasable strap may be secured about the torso of the patient to hold the mount in place on the patient's chest.

In an embodiment, the present subject matter relates to an automated cardiopulmonary resuscitation apparatus, comprising: a linear actuator including an extendable and retractable piston; a mount adapted for positioning the linear actuator above a chest of a patient; at least one sensor for measuring a pulse of the patient and a blood oxygen level of the patient; and a controller in communication with the linear actuator and the at least one sensor, the controller being configured to: drive the linear actuator to reciprocally extend and retract the piston such that a free end of the piston compresses the chest of the patient at a regular interval; and cease operation of the linear actuator when the pulse of the patient is determined to be at or above a first predetermined threshold.

These and other features of the present subject matter will become readily apparent upon further review of the following specification.

### BRIEF DESCRIPTION OF DRAWINGS

FIG. 1A is a partially cut-away, side environmental view of an automated cardiopulmonary resuscitation apparatus.

FIG. 1B is a partially cut-away, side environmental view of the automated cardiopulmonary resuscitation apparatus, with a piston thereof shown in a fully extended position.

FIG. 2 is a block diagram illustrating system components of the automated cardiopulmonary resuscitation apparatus.

Similar reference characters denote corresponding features consistently throughout the attached drawings.

### DETAILED DESCRIPTION

The present subject matter relates to an automated cardiopulmonary resuscitation apparatus, comprising: a linear actuator including an extendable and retractable piston; a mount adapted for positioning the linear actuator above a chest of a patient; at least one sensor for measuring a pulse of the patient and a blood oxygen level of the patient; and a controller in communication with the linear actuator and the at least one sensor, the controller being configured to: drive the linear actuator to reciprocally extend and retract the piston such that a free end of the piston compresses the chest of the patient at a regular interval; and cease operation of the linear actuator when the pulse of the patient is determined to be at or above a first predetermined threshold.

In an embodiment, the present apparatus starts working once the at least one sensor, including by way of non-limiting example a heart rate sensor, pulse sensor, and/or blood oxygen level sensor, is placed on the patient's finger to measure pulse rate and how much oxygen is in the blood. The sensor will send those readings to the controller. The controller in turn will evaluate these readings against a specific threshold, which helps indicate the state of the patient's heart, i.e., whether it is beating at a normal rate or not. If the values are below the threshold, i.e., if the patient's blood oxygen saturation level and/or the patient's heartbeat is at or below a predetermined threshold, the controller sends signals to activate the compression process. The heartbeat state along with the compression process state can be displayed on an output screen to provide information to the user. The system can be powered through a portable power source. In an embodiment, the present apparatus is fully automated; that is, once the apparatus is placed on the patient, no further input from or interaction with a user is required for the apparatus to complete its full operation.

In an embodiment, the controller is configured to not only start and stop operation of the apparatus when the predetermined thresholds are met, but to also define the number of required compression cycles for the piston, as well as the amount of force applied to the patient's chest by the piston.

In a further embodiment, the present apparatus can optionally include means for providing an electric shock to the patient through a contact point with the patient's chest, such as the piston when it is in its fully extended position. This electric shock can further assist in helping the patient's pulse reach or exceed the predetermined minimum level.

In another embodiment, the present apparatus can further include means for converting movement of the linear actuator into electrical energy, which can be used to help power the device and/or power the optional electric shock delivered to the patient. Such means can result in an overall energy savings.

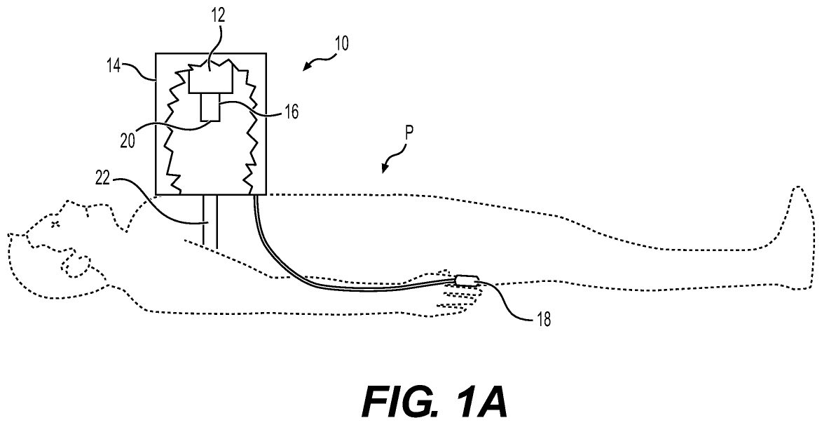

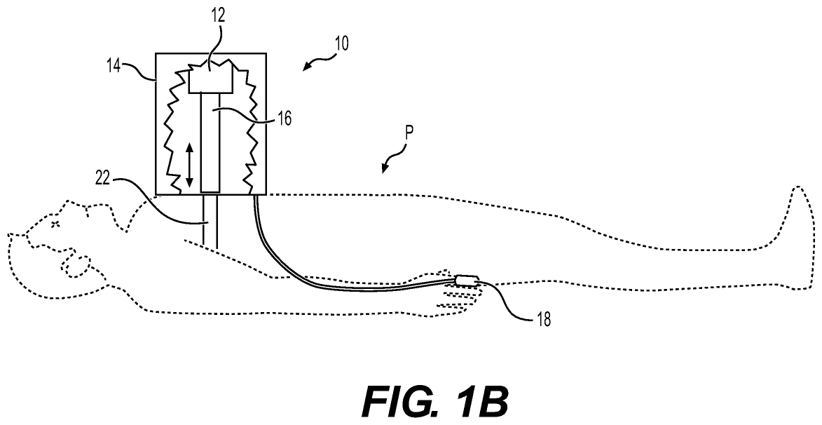

The automated cardiopulmonary resuscitation apparatus IO is a portable device for automatically performing chest compression on a patient in need thereof. As shown in FIGS. 1A and 1B, the automated cardiopulmonary resuscitation apparatus 10 includes a linear actuator 12 having an extendable and retractable piston 16. It should be understood that any suitable type of linear actuator 12 may be used or, alternatively, that any suitable type of linear driver or rotary-to-linear driver may be used for driving linear motion of piston 16. It should be further understood that piston 16 is shown in FIGS. 1A and 1B for exemplary purposes only and may have any suitable shape and relative dimensions. As a non-limiting example, piston 16 may be cylindrical with a length of approximately 12 inches. Piston 16 is preferably made from a relatively flexible material to minimize the chance of injury to the patient P. As a further non-limiting example, piston 16 may be made from a semi-flexible or flexible thermoplastic polyurethane.

A mount 14 is provided for positioning the linear actuator 12 above the chest of the patient P, such that the piston 16 is positioned above the patient's heart. It should be understood that mount 14 is shown in FIGS. 1A and 1B for exemplary purposes only and may have any suitable shape and relative dimensions. As a non-limiting example, mount 14 may be a cylindrical shell with a height of approximately 6.5 inches, with linear actuator 12 mounted within the interior thereof. Mount 14 is preferably made from a relatively lightweight and resilient material to minimize discomfort for the patient P. As a further non-limiting example, mount 14 may be made from polyethylene terephthalate glycol.

At least one sensor is provided for measuring the patient's pulse and blood oxygen level. In the non-limiting example of FIGS. 1A and 1B, the at least one sensor is shown as a conventional fingertip pulse oximeter 18 for measuring both the patient's pulse and blood oxygen level, as is well known in the art. However, it should be understood that any suitable type of separate pulse and blood oxygen level sensors may be used, and it should be further understood that any suitable type of combined pulse and blood oxygen level sensors may be used.

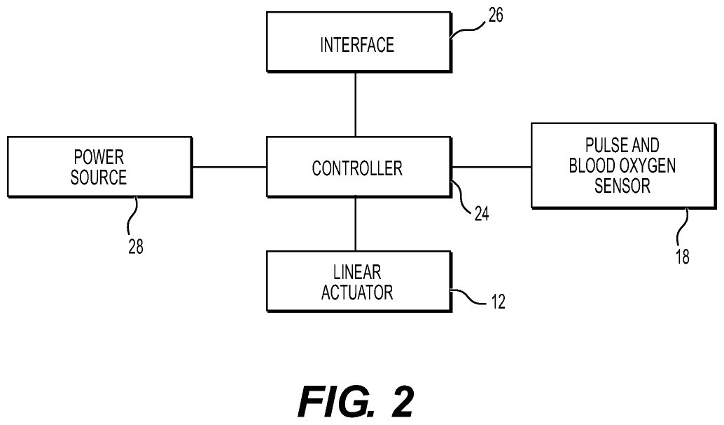

As illustrated in FIG. 2, a controller 24 is in communication with the linear actuator 12 and the pulse and blood oxygen level sensor 18. It should be understood that controller 24 may be any suitable type of controller, including, but not limited to, a processor, a microprocessor, a computer, a programmable logic controller, control circuitry or the like. The controller 24 is configured to drive the linear actuator 12 to reciprocally extend and retract the piston 16 such that a free end 20 of the piston compresses the chest of the patient at a regular interval. FIG. 1A illustrates the piston 16 in its retracted position and FIG. 1B illustrates the piston 16 in its extended position where compressing contact is made with the patient's chest.

Operation of the linear actuator 12 is ceased when the patient's pulse is determined to be at or above a first predetermined threshold. As a non-limiting example, when the patient's measured pulse rate is at or above a predetermined minimum pulse rate, chest compression is stopped. As another non-limiting example, when the patient's measured pulse strength (or amplitude) is at or above a predetermined minimum pulse strength (or amplitude), chest compression is stopped. Initial operation of the linear actuator 12 may also be based on measurements from the pulse and blood oxygen level sensor 18. The controller 24 may be further configured to initiate operation of the linear actuator 12 when at least one of the patient's pulse and the patient's blood oxygen level is at or below a second predetermined threshold.

An interface 26, such as a touchscreen or the like, may be mounted on an exterior surface of mount 14 for displaying data and/or receiving control commands. When present, the touchscreen can provide a user interface that allows a user, separate from the patient, to visualize or control the process as described herein. The interface 26, controller 24, pulse and blood oxygen level sensor 18, and linear actuator 12 may be powered by any suitable power source 28, such as a rechargeable battery or the like. Additionally, as shown in FIGS. 1A and 1B, the mount 14 may be secured to the patient P using any suitable type of attachment or stabilizer. In the non-limiting example of FIGS. 1A and 1B, a releasable strap 22 is secured about the torso of the patient P to hold the mount 14 in place on the patient's chest. It should be understood that strap 22 is shown for exemplary purposes only and that any suitable type of strap, clamp, frame or the like may be used to hold the mount 14 in place with respect to the patient's chest.

It is to be understood that the automated cardiopulmonary resuscitation apparatus is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. An automated cardiopulmonary resuscitation apparatus, comprising:
a linear actuator including an extendable and retractable piston;
a mount adapted for positioning the linear actuator above a chest of a patient, wherein the mount encloses the linear actuator including the extendable and retractable piston during an extension and retraction of the extendable and retractable piston, wherein a bottom surface of the mount contacts the chest of the patient;
at least one sensor for measuring a pulse of the patient and a blood oxygen level of the patient; and
a controller in communication with the linear actuator and the at least one sensor, the controller being configured to:
drive the linear actuator to reciprocally extend and retract the piston such that a free end of the piston compresses the chest of the patient at a regular interval; and
cease operation of the linear actuator when the pulse of the patient is determined to be at or above a first predetermined threshold, wherein the measuring of the pulse of the patient includes measuring both a pulse rate and a pulse amplitude and wherein the first predetermined threshold includes a predetermined minimum pulse rate component and a predetermined minimum pulse amplitude component.

2. The automated cardiopulmonary resuscitation apparatus as recited in claim 1, wherein the controller is further configured to initiate operation of the linear actuator when at least one of the pulse of the patient and the blood oxygen level of the patient is at or below a respective second predetermined threshold.

3-4. (canceled)

5. The automated cardiopulmonary resuscitation apparatus as recited in claim 1, further comprising means for securing the mount to the patient.

6. The automated cardiopulmonary resuscitation apparatus as recited in claim 5, wherein said means for securing the mount to the patient comprises a strap adapted to be secured about a torso of the patient.

7. The automated cardiopulmonary resuscitation apparatus as recited in claim 1, wherein the mount comprises a cylindrical shell.

8. The automated cardiopulmonary resuscitation apparatus as recited in claim 1, wherein the mount is comprised of polyethylene terephthalate glycol.

9. The automated cardiopulmonary resuscitation apparatus as recited in claim 1, wherein the piston is comprised of thermoplastic polyurethane.

10. The automated cardiopulmonary resuscitation apparatus as recited in claim 6, whereby the piston is positioned above a heart of the patient.

11. The automated cardiopulmonary resuscitation apparatus as recited in claim 2, wherein the second predetermined threshold is a predetermined minimum pulse of the patient or a predetermined minimum blood oxygen level of the patient.

12. The automated cardiopulmonary resuscitation apparatus as recited in claim 1, wherein the controller is further configured to define a number of required compression cycles for the piston, as well as a force applied to the chest of the patient by the piston.

13-15. (canceled)
